(19) United States
(12) Patent Application Publication
(10) Pub. No.: US 2025/0363202 A1
(43) Pub. Date: Nov. 27, 2025

(54) SYSTEM AND METHOD FOR PRIVACY PRESERVING FEDERATED MACHINE LEARNING

(71) Applicant: ROYAL BANK OF CANADA, Toronto (CA)

(72) Inventors: Iustina-Miruna VINTILA, Bucharest (RO); Ehsan AMJADIAN, Toronto (CA); Edison U. ORTIZ, Orlando, FL (US)

(21) Appl. No.: 19/218,082

(22) Filed: May 23, 2025

Related U.S. Application Data
(60) Provisional application No. 63/651,218, filed on May 23, 2024.

(51) Int. Cl. G06F 21/53; G06N 20/00

(52) U.S. Cl. CPC G06F 21/53; G06N 20/00

(57) ABSTRACT

An improved approach for confidential federated machine learning and in particular, federated inference is proposed that is configured for coordinated interoperation of local computing instances that are separate from one another that operate with a model aggregator, and there are separate global and local model data architectures that are being updated periodically. Confidential embeddings in the form of representations of determined gradients determined based on local training using local data, for example, are passed securely between instances.

### CROSS REFERENCE

This application is a non-provisional of, and claims all benefit including priority from, U.S. Application No. 63/651,218, filed May 23, 2024, entitled SYSTEMS AND METHODS FOR PRIVACY PRESERVING FEDERATED MACHINE LEARNING. The application is incorporated by reference in its entirety.

### FIELD

Embodiments of the present disclosure relate to the field of machine learning, and more specifically, embodiments relate to devices, systems and methods for improved secure federated machine learning platforms configured with specific technical safeguards that preserve confidentiality between operating computing components and their associated entities. An improved computing architecture for federated retrieval augmented generation approaches is proposed that supports private computing and enhances cybersecurity using confidential computing approaches by distributing specific computing tasks between local and global computing instances.

### INTRODUCTION

The increasing use of data for improved insights and decision making through machine learning has made data an asset which data owners may wish to exploit. However, there is substantial risk when a data owner provides confidential data for machine learning when the outputs may be accessed by external parties.

The need to ensure that data stays protected when used for machine learning may require the party responsible for the machine learning model to take on substantial costs and infrastructure to store, maintain and protect the large quantities of confidential data being used within their models.

A developing use case is multi-party analytics and insights, especially when other technical alternatives, such as cross-site and session cookies may no longer be viable. There is an increasing need to preserve privacy as between the parties, as there may be value in being able to collaborate despite being custodians of sensitive information.

Example situations where there are benefits to these types of approaches include conducting machine learning on large data sets of sensitive data that are held at different entities, such as different insurance or health networks. These entities may wish to collaborate to conduct research in respect to a particular difficult to cure disease, such as attempting to identify core demographics for increased research funding, or generating an accurate view of the overall disease burden to ensure that resources can be allocated for treatment or research. For example, as a bank cannot share sensitive customer financial profiles data, merchants also cannot share proprietary purchase-pattern insights, and these regulatory constraints pose a challenge to collaboration.

Extrapolating from these direct use cases include analytics where instead of direct query results, machine learning models are trained/maintained over time or queried in inference operation. The queries or query results, when exposed to the larger available data sets, may have improved accuracy, predictive capabilities, or relevance to a particular use case, and similarly, it is desirable to be able to conduct machine learning in a federated approach using confidential computing technologies, where data custodians can collaborate on analytics without directly exposing or sharing their underlying data.

It is technically challenging to conduct machine learning on an always protected database, and proposed approaches are described herein. Implementing a privacy preserving, personalized recommendation system which addresses data privacy, regulatory requirements, can unlock technical collaboration opportunities and provide better value for the customer and merchants.

### SUMMARY

A computer implemented system for a federated machine learning orchestration environment maintaining an always protected processing subsystem is proposed that is adapted for federated inference operation.

The system comprises a computer readable memory having a protected memory region that is encrypted such that it is inaccessible to both an operating system and kernel system, the protected memory region including at least a data storage region and a data processing subsystem storage region maintaining the always protected data processing subsystem; a computer readable cache memory; and a secure enclave data processor.

The secure enclave data processor is configured to: receive a new query data object, transmit the new query data object to a plurality of target secure enclave data processors, each corresponding to a local machine learning orchestration environment. Each of the target secure enclave data processors represent local nodes that can be data custodians of data that is private to a particular local node.

Each of the target secure enclave data processors operates a local machine learning model in an inference mode to first retrieve from a local data storage relevant local data records, and then operates the local machine learning model to generate an intermediate response to the new query data object using the new query data object augmented with one or more private embeddings corresponding to the retrieved relevant local data records. Accordingly, a local level of RAG operation is conducted using local data records, which are private to each of the target secure enclave data processors that represent local nodes.

The orchestrator receives a plurality of intermediate responses from each of the target secure enclave data processors, and then inserts the plurality of intermediate responses into a consolidated data structure, that, for example, can be a prompt data structure that has ranked slots. The consolidated data structure is processed by operating a global machine learning model in an inference mode against the consolidated data structure and the new query data object to generate an output data object representing a predictive response to the new query data object. This predictive response combines responses generated using the sensitive data local to each of the local nodes without requiring direct access to query the sensitive data of each of the local nodes.

The orchestrator then transmits the output data object representing the predictive response to a user interface computing system configured for dynamically rendering one or more visualization outputs based on the output data object and the predictive response.

The local machine learning model and the global machine learning model can both a same version of a trained large language model, and in some embodiments, there can be federated training in addition to federated inference. This can operate, for example, where after generating the output data object, the global machine learning model is retrained using the plurality of intermediate responses. This retraining can be conducted on a periodic basis on periodic batches of intermediate responses to more efficiently conduct training operations.

After retraining of the global machine learning model, model update gradients are generated, and these model update gradients can be transmitted to each of the plurality of target secure enclave data processors, each of the plurality of target secure enclave data processors configured to update the corresponding local machine learning model using the model update gradients. The federated retraining is not required in all embodiments and is an additional feature of a proposed variant.

The consolidated data structure is structured as a prompt having a plurality of ranked slots (e.g., an array of strings with corresponding rankings), and the secure enclave data processor is configured to operate the global machine learning model in the inference mode upon receiving the plurality of intermediate responses to rank each of the plurality of intermediate responses based on relevance to the new query data object, and to insert the plurality of intermediate responses into the ranked slots of the prompt. By ranking the responses, the prompt can serve a conflict resolution function by including a prompt instruction to bias the generation of the output data object to weight higher ranked intermediate responses over lower ranked intermediate responses of the plurality of ranked slots.

The new query data object can also be coupled with additional metadata such as access credential metadata that, for example, can be based on a user identifier of the requesting party or computing device, and the access credential metadata is utilized by each of the local machine learning model to control which of the relevant local data records of the local data storage are made available for generation of the intermediate response. Accordingly, for a same request query, there can be different results depending on the access identifier. The access credential metadata can also be used to identify which of the plurality of target secure enclave data processors can be used to process the query to generate the intermediate results for consolidation.

The computer implemented system can be a special purpose machine specifically adapted for the federated machine learning orchestration environment resides in a data center and is coupled to a message bus to receive the new query data object from a user interface coupled to a terminal device associated with a user and to transmit the new query data object to the plurality of target secure enclave data processors.

Improved machine learning architectures are also proposed that provide systems and methods which are capable of establishing and enforcing data contracts which ensure that the data quality metrics of each local client are sufficient to ensure that local models within the federated machine learning system interact well (e.g., do not damage) the global model. This can have impacts, for example, in relation to operational accuracy, speed, and computational efficiency given finite computational resources.

An orchestration system is configured to provide the oversight and monitoring to ensure that a data set used for each local model meets the predefined quality metrics before that local model is selected for federated training. The orchestration system further tracks the execution and data set version as it passes through the machine learning flow.

Structural components include, but are not limited to, a local trusted execution environment which is configured to train a local machine learning model and store the resulting model metrics and results within one or more secure databases, a global trusted execution environment for aggregating local models within a federated global model, a model aggregator which generates a global model, one or more global databases for storing the global models and training results, and a machine learning orchestrator operating within the global trusted execution environment.

In use, the local trusted execution environment, global trusted execution environment, machine learning orchestrator and model aggregator interoperate to perform steps of a method including, but not limited to receiving client data, authorizing and validating data owner and data quality, training local model on local client data to generate insight data and further models, transmitting model metrics, user information and training performance to a machine learning orchestrator, aggregating the local models and augmenting the global model based on local model optimization, verifying the local model data quality using the machine learning orchestrator, generating an updated global model version and augmenting local models through the machine learning orchestrator.

The system may operate in a centralized or decentralized environment, where local model, including client data, are stored within the local clients trusted execution environment, and the global model, including outputs from the local models, are stored within a trusted execution environment of the service provider. The system is configured to interoperate with local client systems, including adaptations for low AI-capability users and local clients.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a data flow diagram for operation of an example system for a federated machine learning platform controlled through an orchestration system, according to some embodiments.

FIG. 2A is a data flow diagram for operation of an example trusted execution environment within a system for a federated machine learning platform controlled through an orchestration system, according to some embodiments.

FIG. 2B is a data flow diagram for operation of an example system output for a federated machine learning platform controlled through an orchestration system, according to some embodiments.

FIG. 2C is a data flow diagram for operation of an example system for federated machine learning platform controlled through an orchestration system having client accessible portals, according to some embodiments.

FIG. 3 is a component diagram of an example system for a federated machine learning platform controlled through an orchestration system, according to some embodiments.

FIG. 4 is a schematic diagram of a computing device such as a server which is configured to implement the proposed federated machine learning platform, according to some embodiments.

FIG. 5 is a block schematic for a practical implementation variation of the federated confidential machine learning approach used in respect of a large language model recommender engine, according to some embodiments.

FIG. 6 is an example process diagram showing an example method for federated LLM operating in a federated RAG configuration, according to some embodiments.

### DETAILED DESCRIPTION

The approaches proposed herein are directed to specific computing improvements that propose improved computing architectures, computing processes, and computer interaction between physical hardware computing devices.

An improved approach for confidential federated machine learning and in particular, federated inference is proposed that is configured for coordinated interoperation of local computing instances that are separate from one another that operate with a model aggregator, and there are separate global and local model data architectures that are being updated periodically. Confidential embeddings in the form of representations of determined gradients determined based on local training using local data, for example, are passed securely between instances.

A specific proposed practical use case and architecture described herein is a confidential, federated machine learning architecture that implements a distributed large language model-based retrieval augmented generation (RAG) recommender computer system across a set of distributed computing nodes that are configured with specific technical segregation enforcing privacy/segregation reflecting that the nodes do not (or cannot) trust one another. From a practical perspective, a LLM-based product recommender having proposed architectures can be adapted to generate computer outputs representative of recommended personalized products, in-line to user's goals and personas, with computational mechanisms to enforce confidential, verifiable, federated computing. By segregating the retrieval and augmentation steps, the proposed architecture protects data custodian queries, along with their own data sets.

As described in further detail herein, when parties who do not trust each other wish to collaborate and share data, a trusted execution environment (TEE, in this example, which can be a confidential virtual machine or container) may be used to store the confidential data within encrypted tables which are protected through an encryption key. The encryption key may be inaccessible to all parties such that a secure container is created which stores the data of all parties. The TEE may be configured as a one way access platform such that parties are restricted to preapproved queries which ensure the confidential data stays protected.

A benefit of using the TEE in accordance with a proposed architecture described herein is that there are reduced cybersecurity risks in the event of a breach, such as a compromised local node, or a compromised orchestrator. In particular, the types of security risks can include risks of direct data access, and more sophisticated approaches that attempt to reconstruct data or queries from embeddings. As noted herein, the impact of both of these are reduced through implementing confidential federated RAG. Relative to a centralized RAG approach, the impact of embedding loss and subsequent reconstruction is reduced because only embeddings are exposed, and no single party is able to see the complete embedding.

Data embeddings are encrypted in traffic and at rest, protected at runtime. Raw data is only stored at custodian site, and only encrypted query and embeddings are sent to orchestrator Data custodians share only embeddings of data chunks representing embeddings/gradients (not raw data) with a central orchestrator. Only send embeddings of the specific RAG data required for the query are sent, and the approach avoids sending embeddings for sensitive or unnecessary data. Finally, the local nodes and global nodes can also be configured to enforce very restrictive access control list (ACL) policies to restrict access to data, such as limiting access to only specific application programming interface calls and functions, as well as encrypted user sessions. If the local models, and transmitted/received data chunks are received and stored on the TEE or associated storage, it is even more difficult to obtain the data even with the local node being compromised (but the TEE encryption key remaining uncompromised). The underlying TEE encryption key can be coupled to a secure TEE processor and the ACL limited process/function execution so that even the local node's operating system and kernel programs are not able to directly access or query the local model to obtain the local model's weights and trained parameters.

During operation, encrypted sessions are maintained and tracked, and for interactions between specific TEEs, such as to transmit gradients, attestations may be required as part of an authorization process to both verify deployment integrity and enforced ACL policies. The authorization process may be required as a handshake before a secure channel is used for communication between the local node and the global node.

TEEs may interoperate with machine learning models to protect that large quantities of data which are needed for training and operating these models. However, the quantity of data needed to operate machine learning models, and ensure its protection centrally, may be cost intensive due to the infrastructure and time needed to maintain and use the data. In the approach proposed herein, the TEEs between different instances have established secure communication channels for the transmission and receiving of data sets corresponding to specific embeddings representative of determined gradients.

From the perspective of a local node, there can be incoming gradients received from a global model aggregator representing updates that are being generated at a global model level, as well as outgoing gradients that are determined by operating the local model with local data, and the gradients are transmitted back to the global model. From the perspective of a global node, there can be incoming gradients received from local nodes operating the local model with local data, and outgoing gradients transmitted to local nodes representing updates that are being generated at a global model level.

Federated learning may be used to allow machine learning models to be trained on multiple local TEEs using local data secured within the infrastructure of local data owners, and the results from the local training can be used to augment a global machine learning model housed within a federated TEE. In some embodiments, the underlying data used for training the local models are maintained within the local infrastructure, and are not provided to the federated TEE. In another variant embodiment, the underlying data may be provided but local models are trained at individual TEE for ultimately updating the global machine learning model.

Federated learning can be further leveraged to provide third party clients with federated inference results using the trained global model. For example, multiple TEEs can be used to run sharded versions of the federated learning model, and this can be especially helpful to share a computational load when the model is particularly large (e.g., thousands or millions of dimensions), enabling a level of parallelization of the overall compute requirements.

Clients may be banks or merchants who interact with the federated ML platform and agree to the conditions of use and data contracts. In some embodiments clients may be personal clients, business clients, asset owners or asset customers. Personal clients may be individual entities which use the federated ML platform in a personal capacity such as a merchant or vendor. In this example, a merchant may operate a local node and seeks to provide more personalized insights to customers, despite having a wealth of data on their side. The merchant may be reluctant to share sensitive data with third parties. Another local node may be operated by a bank, which has additional insights into customer banking profile and would like to expand its offers to be specific to client's needs, but preserving data privacy is a key requirement.

In this example, a federation is formed from 2 parties—bank and merchant which are using the platform for collaborating to train a model jointly, using synthetic and public data sets. The model's objective was to predict the product which will most likely be purchased by the customer, during his next shopping trip. The underlying platform is a computational solution that provides a unified approach to confidential, collaborative, verifiable AI models and applications from state-of-the-art frameworks, architectures and processes.

Business clients may be commercial entities which us the federated ML platform on behalf of their business such as banks and corporate merchants or vendors. Asset owners may be either data owners or model owners who are responsible for managing local models, or for providing input data to the local models. Asset consumers may be clients who have access to the outputs of the federated ML platform. The service provider may be responsible for managing the global model and aggregating the local models while ensuring privacy and security of the federated ML platform. The approach provides a technical architecture for supporting a collaboration between both organizations, where they can generate insights jointly, without directly sharing their data assets and protecting them at rest, in motion and during computations has clear benefits for both.

Clients may be able to interact with the federated ML platform through channels which can be established by the service provider, these channels may include mobile applications or online portals which provide the clients with a user interface and interactive display which may allow the client to access results, input local data, review local model flows or assess data quality metrics.

A data owner is the owner of the data provided to the machine learning platform. The model owner provides the machine learning model either as code or as a trained model, to the machine learning platform. The service provider party provides the computation platform for the machine learning tasks, such as training and serving, and delivers the machine learning output. The output can be another machine learning model which can be further used in other machine learning tasks.

A federation is formed between different local nodes, which provides governance with formal contracts and underlying computing processes for joining and leaving a federation, which are adapted to protect the integrity and security of the data and models. From a technical perspective, joining a federation may require attestations for: data quality, model code, application orchestration, an orchestration flow, that the model code is authentic and not malicious, among others. There may also be contractual obligations that are represented in the form of schema constraints, such as data sets to abide by certain quality metrics, certain sizes, and data schemas and who has access to the data and model assets, as well as the specific data contracts between parties governing the local rules that indicate what interactions are permitted. When leaving the federation, the approach may further include assessing algorithmic fairness & model performance risks as without data contributions from one party during training, there may be an increased risk of bias and imbalance of the global model.

Access control mechanisms are also implemented that control fine grained access control of the data and model, and these are practically implemented into the authorization layer. Different types of access controls are possible, including rule based (e.g., data analysts at merchant site can access aggregated order data for their customers), purpose based (e.g., data sets are only used for federated learning purposes, not for reporting or other analysis), time based (e.g., data sets are shared between parties for certain periods of time (i.e. only 2 days, during federated training), and field/column level control (sensitive columns such as SKU prices).

As described herein, data management and data validation mechanisms are used for controlling data load and output to support complex data loading and validation scenarios to ensure accurate and timely insights are generated. There may be federated statistics across parties as well as validation checks in accordance with a data roadmap, being used for Validation of the data at large, across federation. The statistical properties tracked across a federation for all data sets can be used to verify non-IID aspects, quality, data drift, etc. These can be established in a multi-tenant and federated environment, and are important where there are privacy guarantees as validation can otherwise be difficult by any one party to do of the overall performance due the privacy mechanisms impeding an ability to otherwise observe or query. For continuous learning and feedback loops or in scenarios where local data sets are larger, there is a need to have a streaming data loading component integrated with local federated training process.

Application-level orchestration can be used to support activities before and after federated training processes, such as: key management, data load, data protection, access control policies for assets: data, models, data quality verification, trained model protection, etc. Different workflow types for federated learning can be supported, such as scatter-gather, cyclic, swarm learning, among others. Specifically for large language model implementation, LLM evaluation can be complex and approaches can be adapted for early monitoring and detection of data drifts for ensuring that model performance remains effective, accurate and relevant. Model performance monitoring can be conducted both at the local level (federated party) and at the global aggregator site, and validated against model metrics during training and validation, such as: F1 score, accuracy, loss function, etc.

Model explainability can be incorporated by implementing explainability techniques such as SHAP or others, will help to observe the importance of each input feature of the model, while keeping data private in the federation. These can assist with explaining the causes of concept drift or the reasons behind model adaptations, and explaining model predictions allows end users to understand and trust the system's behavior in dynamic environments.

From a computational perspective, as described herein, the confidential computing infrastructure (confidential VMs, confidential containers, GPUs) are specifically adapted to protect the computational processes during federated data processing, local training, model aggregation and evaluation. A confidential (multi) GPU cloud during federated training time can be orchestrated at training time, where each participating node has a confidential VM and confidential GPU. In this implementation, the load can also be parallelized to obtain better scalability.

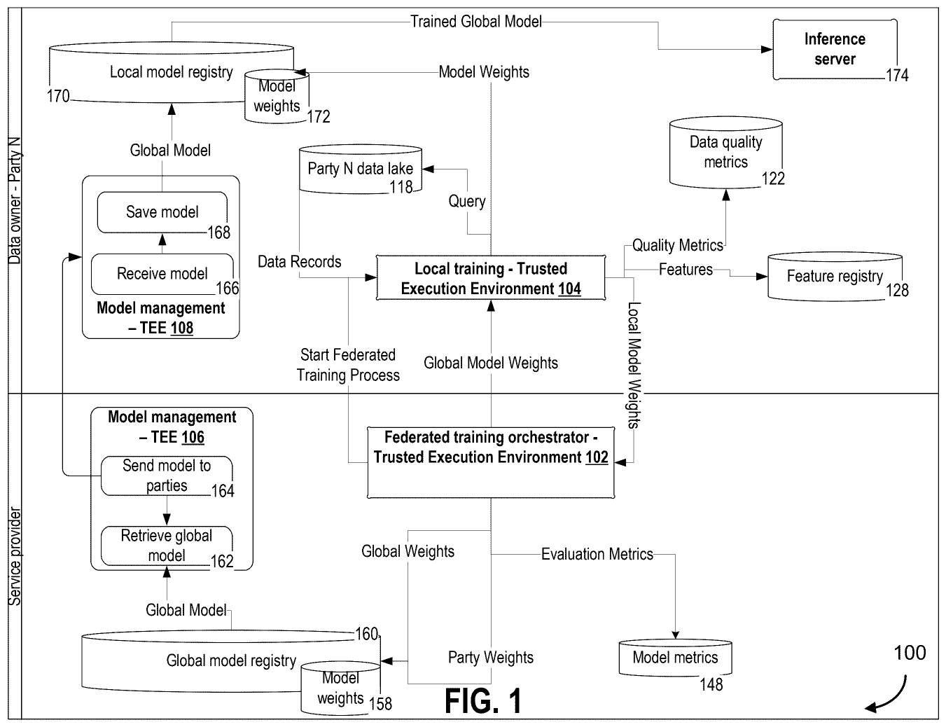

In FIG. 1, a data flow diagram for operation of an example system for federated machine learning platform controlled through an orchestration system is shown.

The embodiment described in FIG. 1 provides a means for managing data, model assets and confidential computational workflows via an orchestration system. The orchestration system may be configured to track and measure data and model quality to ensure that data assets and models conform to agreed upon data quality metric contracts. Data and federated machine learning workflows may be executed within TEEs at the global and local levels. A local TEE may be accessible by a data owner through a dashboard containing an interactive user interface, providing the data owner with the ability to track and adjust input data and model flow. The global TEE may be accessible by a data owner through a dashboard and interactive user interface, providing the service provider with the ability to track and monitor model aggregation and version performance.

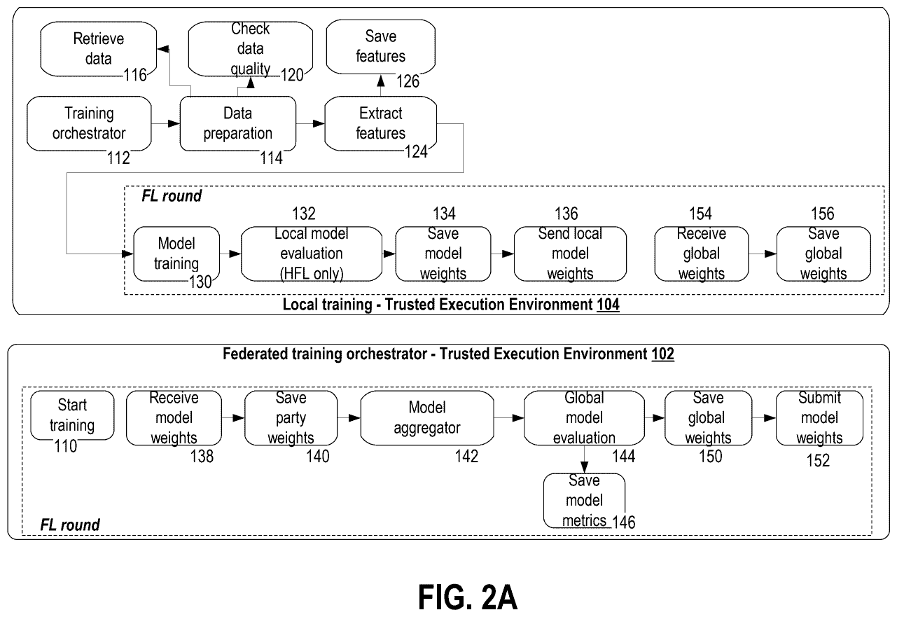

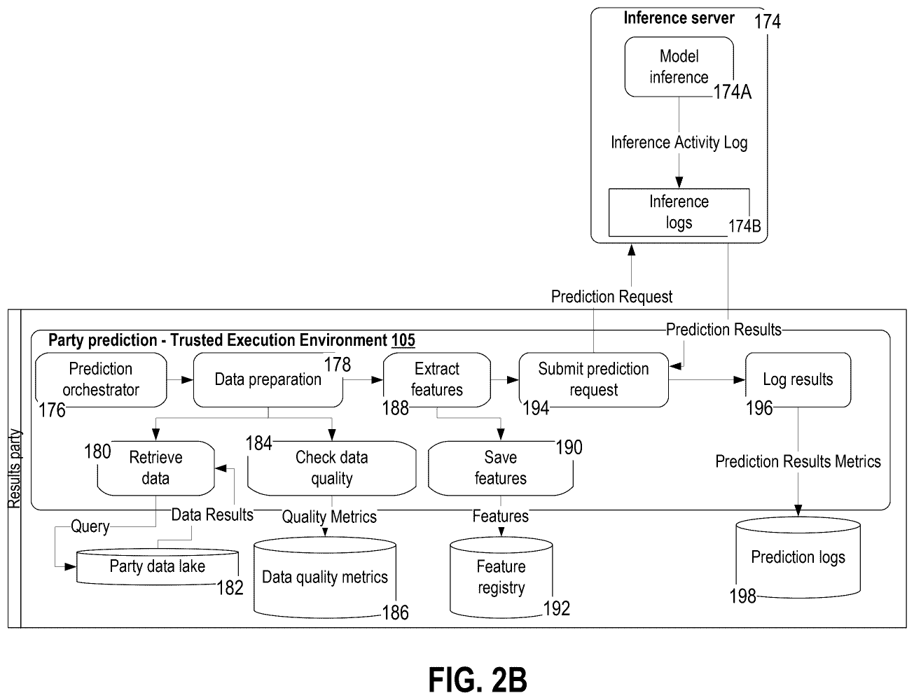

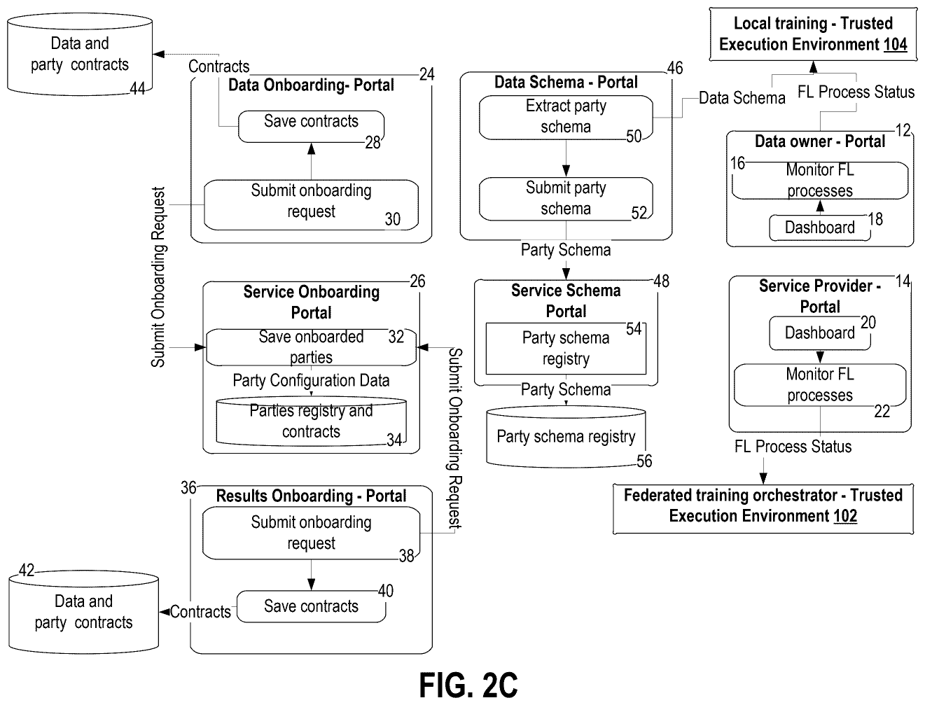

FIG. 1 contains a system 100 for a federated learning process comprising a Federated TEE 102 which is configured to coordinate the federated learning process with the local data and model owners and a local TEE 104 which is configured to monitor and coordinate local model training using data provided by the data owner and update the local model based on augmented versions provided by the federated TEE 102. The local TEE 104 operates within the data owners' internal systems, providing the data owners with a containerized environment where they can upload private data and execute federated model training workflows. FIG. 2A shows the data flow diagram for operation of the local and global trusted execution environment 100A within the system 100 for a federated machine learning platform controlled through an orchestration system.

The federated TEE 102 and local TEE 104 are configured to protect the confidentiality of the computations executed within the TEE.

In system 100 and 100A, the system is configured to start training 110 by communicating with the training orchestrator 112 to initiate the federated training process of the local model within the local TEE 102. Training orchestrator 112 is configured to monitor the training of the local model and to orchestrate the training flow within the local TEE 102. Training orchestration 112 controls data preparation 114 to retrieve data 116 from the local party's data storage memory 118. Data storage memory 118 is a private container which securely stores the data owners' raw data for use with the local model.

A data preparation engine 114 is configured to access the data storage memory 118 through queries to retrieve the required raw data for subsequent computations and transformations needed for local model training. The data preparation engine 114 may validate, transform or calculate the data necessary for extracting features 124. Extracting features 124 is an engine that is configured to receive the prepared data from data preparation 114 and store the features within the raw data for local model training. Extract features engine 124 may either be configured to have features pre-defined for extraction or to compute (e.g., identify) features for extraction based on instructions from the training orchestrator 112. Extract features engine 124 may communicate with the save feature 126. Save feature 126 may be configured to query the extract features engine 124 to retrieve extracted features and store them within feature registry 128. Feature registry 128 may store data set features required for the machine learning workflow, both during training and generating inferences.

The features extracted at the extract features engine 124 may pertain to features relating to specific transactions or customers which are identifiable from one or more local data points stored within data lake 118. In some embodiments, features extracted by extract features engine 124 may include average spend amount per month, maximum number of orders for the selected merchant, minimum account balance, and the like.

Data preparation engine 114 may also be configured to assess, using check data quality 120, the data quality metrics of the data received from the data storage memory 118. The data quality metrics of the raw data may be used to determine whether the raw data from the data owner meets the standards of the federated learning process. The data quality standards may be determined based on a data quality contract which the data owner agreed to prior to implementing the federated learning process within their local architecture. The data quality metrics database 122 stores respective data sets quality rules and evaluation metrics which can be used by check data quality 120 to measures how well a dataset meets criteria for accuracy, completeness, validity, consistency, uniqueness, timeliness and fitness for purpose. If the data quality metrics are insufficient, the local model may have a weight adjustment when the training results are provided to the global federated TEE 102, or the raw data may be rejected outright to protect the federated learning system from being adversely affected by the local model's unreliable outputs. In some embodiments, the results from the assessment performed by check data quality 120 may be used to track the quality of the data provided by the data owner in order to assess the value and usage of the data owner's assets when determining payments or rewards (i.e. to encourage data owner's to develop the infrastructure and practices necessary to provide high quality data).

Once the features have been extracted from the prepared data, the local TEE 104 may initiate training of the local model using the extracted features from extract features 124. Model training engine 130 may be configured to train the model locally within each data owners' local environment. Upon completion of model training by engine 130, the local model is evaluated by local model evaluation engine 132 which is configured to generate a model weight based on the performance metrics of the local model after each local model training round. The model weights generated by the local model evaluation engine 132 are retrieved by save model weights engine 134 which stores the model weights until a query is generated by send local model weights engine 136. When send local model weights engine 136 generates a query, save model weights engine 134 transmits the local model weight to the federated TEE 102 for use in the federated training flow. In some embodiments, save model weights 134 may reduce the temporal complexity of having a plurality of local models, each having different run times, providing model weights to a single federated TEE 102. Save model weights engine 134 may save the local model weights within the local environment in order to provide traceability of model training and versions. In some embodiments, save model weights engine 134 may provide a storage means for each local model to store the local model weights corresponding to a round of training until the federated TEE 102 is prepared to receive the local model weights from send local model weights 136, thereby providing a method to control the varying upgrade timelines and schedules.

In some embodiments, the local model weights are saved, by the save model weights engine 134, once the local training round is completed. The duration of the training round for a local model may vary based on the size of the local data input, the local model and computation size, the local environment resources, and the like.

The local model weights are saved after the local training round is completed. The duration of the training round depends on the local data size, model and computation complexity, local environment resources etc.

The local model weights are transmitted to receive model weights engine 138 within the federated TEE 102 from the local TEE 104. The local model weights from all of the local models are collected at receive model weights engine 138 and stored within the federated TEE 102 as party weights at save party weights engine 140. Party weights may comprise the local model weights generated from a training round along with an identifier corresponding to the local model which generated the local model weights. Save party weights 140 transmits the party weights to the global model registry 160, the global model registry 160 being configured to store party weights and the corresponding global weights (generated after further processing in the federated TEE 102) for each round of training. The party weights are also transmitted by save party weights 140 to the model aggregator 142. The model aggregator 142 is configured to perform local model aggregations to obtain a new version of the global model. Within model aggregator 142 are pre-defined algorithms for federated aggregations, which may include secure aggregators, hierarchical aggregators and decentralized aggregators.

Once model aggregator 142 has generated an augmented global model based on the party weights, global model evaluator 144 evaluates the model performance metrics and generates a set of model metrics which are saved by save model metrics engine 146 and stored within model metrics database 148. In some embodiments, the global model metrics saved by save model metrics engine 146 are used to evaluate the global model performance to determine whether the training of the global model, training data, or input data need to be further refined or adjusted. For example, the save model metrics engine 146 may include a repository of F1 scores for the global model, allowing the F1 scores to be monitored to determine if, and when, it falls below a pre-determined threshold. If the F1 score were to fall below a threshold, then the input data, training data or global model can be re-evaluated.

While the global model evaluator 144 ensures that the global model abides by certain quality checks after the end of the local training round, further checks may be performed throughout the federated learning process to ensure that local inputs do not detrimentally impact the global model. Throughout the federated learning process, the global model may be detrimentally impacted through either intentional or unintentional conduct. In a system where unsophisticated parties may be providing local data into the federated system, protections against unintentional conduct which could impact the global model may be necessary. For example, data owners may sporadically cease providing local data into the federated learning environment, data owners may provide insufficient quantities of local data for the local model to achieve sufficient accuracy and reliability, data owners may provide local data which lacks accuracy, lacks the proper distribution or has been corrupted, or data owners may provide local data which contains empty data sets.

As can be seen, there are many ways to potentially poison the global model through unintentional conduct on the part of the local data owner. It therefore may be necessary to ensure that local data abides by certain quality checks throughout the federated learning process. This may protect against a single local data owner, who is providing low quality local data, from damaging the global model, even if the remaining data owners have provided local data which satisfies the local data metric requirements.

In some embodiments, local data which is input into the party data lake 118 may be checked to ensure that it satisfies pre-determined data quality metrics which may be set out in a data contract (discussed further in FIG. 2C) which the data owner agreed to prior to implementing the federated learning infrastructure within their local environment. In some embodiments, local data may be checked when it is transmitted from the party data lake 118 into the model training 130. In some embodiments, local data and the resulting local model which is generated at the end of a training round may be evaluated. In some embodiments, the global model may be evaluated at the end of a training round.

In some embodiments, the local data may be evaluated based on predetermined local data schema adherence (discussed further in FIG. 2C) or privacy standards adherence. To ensure local schema adherence, the metadata of the local data may be tracked within the data owner's local environment and assessed based on data schema requirements stored centrally within a schema repository. The local data schema adherence may be assessed along side the data quality when the local data is uploaded into the party data lake 118 or when the local data is provided for training the local model.

In the event that local data owner inputs have damaged the global model, such as when the global model evaluator 144 determines that the model metrics following a training round are below a pre-determined threshold, it may be necessary to trace and identify the local inputs which caused the detrimental impact. Traceability of local data inputs may be achieved through the use of data lineage metadata which allows the federated training orchestrator housed within the federated TEE 102 to identify the origin of the corrupting local data.

The traceability of local data inputs can be associated with a trust weight value, and the weight value is utilized during the processing of the locally computed model weights to update the weights of the global machine learning model to apply the trust weight value to modify an influence of the locally computed model weights to the weights of the global machine learning model.

For example, the trust weight value can be maintained as a time-stamped metadata value on a data structure, and snapshot versions of the global machine learning model are each maintained with a time-stamped version of the data structure representative of a data integrity score associated with the corresponding snapshot version of the global machine learning model.

The locally computed model weights, before being used to update the weights of the global machine learning model, are used to determine the trust weight value. The trust weight value is based at least on an acceptance variance deviance value determined against a baseline set of reference locally computed model weights, and the baseline set of reference locally computed model weights are generated from a distribution of one or more sets of other locally computed model weights, or generated from a distribution of one or more previous sets of locally computed model weights.

In a variant embodiment, the trust weight value includes at least a component based on how many iterations the locally computed model weights have been used to update the weights of the global machine learning model.

If the data integrity score being maintained on the data structure falls below a pre-defined value, the global machine learning model is rolled back to an earlier snapshot version of the global machine learning model. In some embodiments, the roll back to the earlier snapshot version of the global machine learning model is the most recent snapshot version of the global machine learning model.

In some embodiments, if the federated training orchestrator housed within the federated TEE 102 identifies the origin of the corrupting local data, the federated training orchestrator may take corrective action. In some embodiments, the federated training orchestrator may revert back to a previous global model version based on the global weights stored within global model registry 160. In some embodiments, the previous global model version may be selected based on identifying the most recent global model update which occurred prior to the local data owner, which provided the corrupting local data, joining the federated learning environment.

In a further embodiment, the local data owner which is identified as the origin of the corrupting local data may have the weight attached (i.e. impact on the global model aggregation) to their local model weights reduced. In a further embodiment, the local data owner which is identified as the origin of the corrupting data may have their local model weights zeroed out in the algorithms parsed by model aggregator 142. For example, if the global model evaluation 144 identifies that the F1 performance of a global model version falls below a fitness threshold, then the weight attached to a local training round corresponding to the source (i.e. local data owner) of the corrupting local data may be reduced or zeroed out in the model aggregator 144.

In some embodiments, the data inputs from the source (i.e. local data owner) of the corrupting data may be replaced with mock embeddings to ensure the global model has sufficient inputs to complete the training round. In some embodiments, such as when the federated machine learning environment has a vertical structure, the mock embeddings may include replacing the local data inputs from the source of the corrupting data with zeros, or with averages, sum totals, 6 day rolling window, or t-distributions of the local data which satisfied the data quality metric standards.

Due to the traceability achievable by having features such as data lineage metadata associated with the local data, it may be possible to create a hierarchy of local data owners based on the historic reliability and quality of the local data inputs. In some embodiments, the data owner hierarchy may allow the service provider to augment the federated training environment by offering rewards to data owners for achieving certain thresholds of local data reliability and quality, thereby encouraging best practices among the data owners.

The global model evaluation engine 144 may be configured to generate global model weights which are transmitted to save global weights engine 150, the global model weights are used to augment the global model as a new version based on the federated learning round, and also to augment the local model based on the preferences and configuration of the local client's architecture.

Save global weights is an engine 150 that transmits the global weights corresponding to the federated learning round to the global registry 160. Global registry 160 is configured as a database which is used for maintaining a record of the global models for audit and traceability purposes. Save global weights engine 150 also transmits the global weights, through submit model weights engine 152, to the local TEE 104. Local TEE 104 receives the global weights at receive global weights engine 154 which stores the global weights within the local TEE 104 at save global weights engine 156.

Save global weights engine 156 may also be configured to transmit the global weights to the model weights database 172 within the local model registry 170.

The global model registry 160 stores the global weights, party weights and augmented global model generated by the model aggregator 142 using version identifiers to improve traceability and monitoring of the global model training and global model augments. The federated model management TEE 106 may retrieve the augmented global model generated by model aggregator 142 from the global model registry, along with the global model weights corresponding to the augmented global model.

Once the augmented global machine model has been retrieved by retrieve global model 162, the federated model management TEE 106 transmits the augmented global machine model to the local model management TEE 108, at receive model 166, which allows the model owners to process and implement the augmented global model for local training.

The local model management TEE 108 may be configured to save the augmented global model, along with the model metadata, within the local model registry 170. The local model registry 170 maintains the machine learning models in various formats (e.g., ONNX, PMML) along with the model owner, creation date, version, updated date, status, etc. Within the local model registry 170 is the model weights database 172 which stores the global weights, allowing the global weights to be associated with the resulting augmented global model retrieved from the global model registry 170.

The global model registry 170 is configured to transmit the trained global model to the inference server 174. The trained global model can then be deployed to provide inferences based on queries provided by the results party.

In some embodiments, the inference server 174 may be hosted locally within the local TEE of the results party. When the inference server 174 is stored locally, the results party may have access to the most recently deployed copy of the global model, which can be periodically updated based on the completion of new training rounds. The local hosted inference server 174 may be augmented or customized based on result party specific preferences.

In another embodiment, the inference server 174 may be hosted at the global level and access to the inference server 174 by the results party may be through an inference API. The globally hosted inference server 174 may be updated in real time based on completion of training rounds and the results of the global model evaluation 144.

In FIG. 2B, a data flow diagram for operation of an example system output for a federated machine learning platform controlled through an orchestration system is shown.

The inference server 174 is configured to house and implement the global model within the local TEE 104 in the data owner's environment. The results party may have a prediction TEE 105 within their local environment which is capable of requesting predictions from the inference server 174. Within the prediction TEE 105, a prediction orchestrator monitors and controls the flow of information through the prediction TEE 105. The prediction orchestrator 176 may coordinate the prediction workflow to ensure confidentiality of the computations within the TEE. Prediction orchestrator 176 transmits a command to data preparation 178 which retrieves data 180 from a party data lake 182. Party data lake 182 stores the raw data within a secure private container which can be accessed by the results TEE 105 upon request.

Data preparation 178 may be configured to assess, using check data quality 184, the data quality metrics of the data received from the data storage memory 182. The assessment of the data quality metrics of the raw data may be used to determine whether the raw data from the data owner meets the standards of the federated learning process. The data quality standards may be determined based on a data quality contract which the data owner agreed to prior to implementing the federated learning process within their local architecture. The data quality metrics database 186 stores respective data sets quality rules and evaluation metrics which can be used by check data quality 184 to measures how well a dataset meets criteria for accuracy, completeness, validity, consistency, uniqueness, timeliness, and fitness for purpose. If the data quality metrics are insufficient, the local model may have a weight adjustment when the training results are provided to the global federated TEE 105, or the raw data may be rejected outright to protect the federated learning system from being adversely affected by the local model's unreliable outputs. In some embodiments, the results from the assessment performed by check data quality 184 may be used to track the quality of the data provided by the data owner in order to assess the value and usage of the data owner's assets when determining payments or rewards.

Data preparation 178 may validate, transform, or calculate the data necessary for extract features 188. Extract features 188 is configured to receive the prepared data from data preparation 178 and store the features within the raw data for local model training. Extract features 188 may either be configured to have features pre-defined for extraction or compute features for extraction based on instructions from the prediction orchestrator 176. Extract features 188 may communicate with save feature 190. Save feature 190 may be configured to query Extract features 188 to retrieve extracted features and store them within feature registry 192. Feature registry 192 may store data set features required for the machine learning workflow, both during training and generating inferences.

The extracted features and raw data are transmitted by the prediction orchestrator 176 to the inference server 174 through submit prediction request 194. The prediction request is received by the inference server 174 and used as an input into the global model. The inference server 174 provides a model inference 174A which is transmitted to the prediction TEE 105 and stored within the inference server 174 in an inference log 174B. The prediction result transmitted to the prediction TEE 105 may be stored by log results 196 within a prediction logs database 198.

FIG. 2C a data flow diagram for operation of an example system for federated machine learning platform controlled through an orchestration system having client accessible portals is shown.

A portal or platform to manage the data, model assets and confidential computations workflows via a platform portal may be included for parties with low AI/technical capabilities. A data owner portal 12 may communicate with the local TEE 104 to allow the data owner to manage online federated learning processes, including the onboarding of the local model within their local environment, the training of the local model, and monitoring the data quality, usage, outputs and model weights generated during the model flow. The data owner portal 12 may include a monitoring service 16 which is configured to provide real-time updates for the federated training status, results for each training round. The data owner portal 12 may also include a dashboard 18 which can be accessed by the data owner through an interactive user interface on a display, the dashboard 18 displaying charts and diagrams capturing the status of the federated training and inference services.

In some embodiments, the service provider may communicate with the federated TEE 102 through a service provider portal 14. The service provider portal 14 may be displayed through a web portal on an interactive user interface, which allows the service provider to initiate, interact and monitor the federated learning process. The service provider portal 14 may also include a monitoring service 22 which is configured to provide real-time updates for the federated training status, results for each training round. In some embodiments, the service provider portal 14 may also include a dashboard 20 configured to be displayed on a device having an interactive user interface, the dashboard 20 generating charts and diagrams capturing the status of the federated training and inference services.

In a further embodiment, an onboarding process may occur prior to the local model being implemented within the local environment. The onboarding process may occur within TEEs within the local environments of the data owner, service provider and results party. The onboarding process includes client registration, providing unique identifiers for each client, and determining access control policies and data contracts for each local model.

In some embodiments, the data owner may submit a request to enter the onboarding process, in which the service provider will transmit a data contract and access control policy which the data owner must agree to prior to having the local model implemented within their environment. The data contract and access control policy may then be saved within a data onboarding portal 24 and service onboarding portal 26. The service onboarding portal 26 may also retain the configuration data for the data owner used to implement the local model within the data owner's environment.

The data contracts within the data onboarding portal includes the data owner's contractual information, for operating in the confidential federated learning ecosystem. Items, such as data sets quality metrics, machine learning model performance metrics. The data owner can therefore negotiate and capture the access controls related to the data and model access in these contractual terms. The data onboarding portal 24 may store the data contracts within a data and party contracts database 44 which exists within the local environment and is accessed through save contracts 28. The data and party contracts database 44 stores the contractual terms and conditions between data owner and service aggregator to operate in this platform.

In some embodiments, the results party may also request to enter the onboarding process, which will require the results party to agree to access control policies relating to the use and access to the results from the federated learning model. The results onboarding portal 36 may communicate with the service onboarding portal 26 through submit onboarding request 38. Once the results party has agreed to the contractual terms, the results onboarding portal 36 will save contracts 40 within a data and party contracts database 42 which stores the results party's contractual information, for accessing the machine learning inference results Items, such as data sets quality metrics, machine learning model performance metrics, access controls related to the data and model access can be negotiated and captured in these contractual terms.

The service onboarding portal 26 is configured to receive the onboarding requests from the data owner and results party and validate the request based on acceptance on the part of the data owner and results party agreeing to the data contracts and access policies. The service provider onboarding portal contains a registry and contracts database 34, which can be accessed through save onboarded parties 32, which saves party configuration metadata in the contract database and maintains negotiated and agreed contracts between data owners, service provider and results parties.

The service onboarding database 26 may also be configured to store the results party's contractual information, such as for accessing the machine learning inference results, data sets quality metrics, and machine learning model performance metrics within the party registry and contracts database 34.

In some embodiments, the data owner may have access to a data schema portal 46 which extracts party schema 50 from existing data sets within the local TEE 104 and submits party schema 52 to a service schema portal 48. The service schema portal may be configured to save the party schema 54 within a party schema registry 56 which maintains a history of data schemas and associated metadata (version, owner, created date etc.).

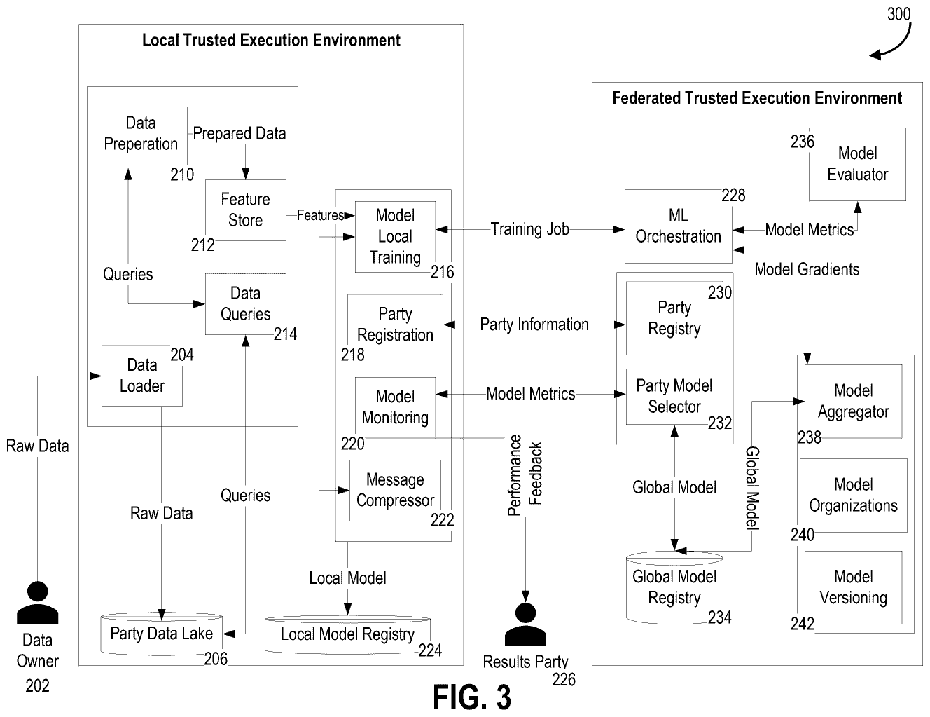

In FIG. 3, a component diagram of an example system 200 for a federated machine learning platform controlled through an orchestration system is shown.

System 200 contains a local TEE and a federated TEE; the local TEE operates within the local environment of data owner 202. Data owner 202 may be a merchant or vendor which uses the local TEE as a containerized environment which they can access to upload private data and execute the federated model training workflows. The data owner 202 has sole access to the data uploaded into their local TEE and the executed model training workflows which occur within their local TEE.

Data owner 202 uploads their raw data into data loader 204 which is configured for receiving and loading the raw datasets from the data owner. In some embodiments, data loader 204 may also validate the raw data uploaded by data owner 202. The uploaded raw data is transmitted to party data lake 206 which stores the raw data sets in a private secure container. Data preparation 210 may provide get requests to the party data lake 206 by commanding data queries 214 to send a query to the party data lake 206. Data queries 214 may be configured to send queries to the party's data lake 206 to retrieve the required data for subsequent computations and transformations. Once data preparation 210 retrieves the raw data sets, the raw data may be validated, transformed and calculated for feature management activities. The prepared data is transmitted to feature store 212 which may be configured to define, compute and store features for model training activities.

The federated machine learning process trains the local model within the local TEE to ensure protection of the Data owners 202 raw inputs and machine learning flows. Model local training 216 interoperates with the federated TEE through ML orchestration 228. ML orchestration 228 may send a command to initiate training workflows and manages the training process by commanding the local model to advance to the next activity in the flow. The model local training 216 trains the model locally within each party's environment and transmits updated model gradients to the federated TEE.

The training environment may include a party registration portal 218 within the local TEE which is configured to initiate the party registration within the federated TEE. The party registration may be configured to transmit the party registration information to the party registry 230 to maintain party information and register parties in the federated learning network. The local TEE may contain a model monitoring 220 function which may be configured to monitor model performance metrics in real time. The model monitoring 220 may communicate with the party model selector 232 within the federated TEE to augment the local model. The party model selector 232 may be configured to deploy the trained models to each local party, based on their local configuration and preferences.

In some embodiments, the model monitoring may be configured to receive feedback from a results party 226 through a results party portal within a results party TEE. The results party 226 may only have access to the data owner prediction results via a black-box access approach, only by exposing a set of APIs to the results party 226 which can then be used to provide the feedback to the model monitoring 220.

Within the local TEE, there may be a message compressor 222 which may be configured to reduce the bandwidth of communications, i.e. compresses the messages, transmitted within the local TEE and externally to the federated TEE to improve the communication efficiency.

The local model which is trained within the local TEE and is stored within the local model registry 224 for audit and traceability purposes.

The ML orchestrator 228 transmits the model metrics retrieved from the training of the local model within the local TEE to the model evaluator 236. The model evaluator 236 is configured to evaluate the local model performance metrics after each model training round. The training of the local model within the local TEE can provide model gradients to the federated TEE which can be used by a model aggregator 238 to perform local model aggregations to obtain a new version of the global model. The model aggregator 238 may be configured to employ different algorithms for federated aggregations, including at least a secure aggregator, hierarchical aggregator, decentralized aggregator, etc.

The augmented global model generated by the model aggregator 238 may be stored within a global model registry 234 which is configured to keep a record of the global models respectively, for audit and traceability purposes.

In a further embodiment, federated TEE may be configured to increment the model version after each model update using a model versioning 242.

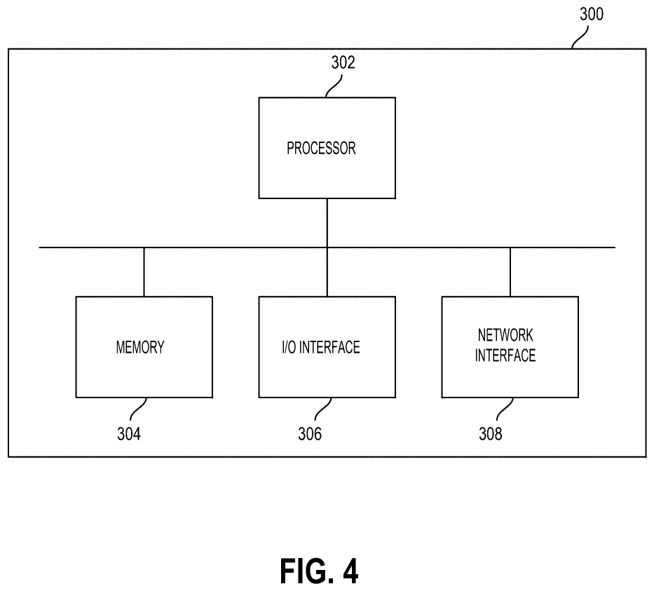

FIG. 4 is a schematic diagram of a computing device 300 such as a server which may implement the proposed system discussed above. As depicted, the computing device includes at least one processor 302, memory 304, at least one I/O interface 306, and at least one network interface 308.

Processor 302 may be an Intel or AMD x86 or x64, PowerPC, ARM processor, or the like. Memory 304 may include a suitable combination of computer memory that is located either internally or externally such as, for example, random-access memory (RAM), read-only memory (ROM), compact disc read-only memory (CDROM).

Each I/O interface 306 enables computing device 300 to interconnect with one or more input devices, such as a keyboard, mouse, camera, touch screen and a microphone, or with one or more output devices such as a display screen and a speaker.

Each network interface 308 enables computing device 300 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

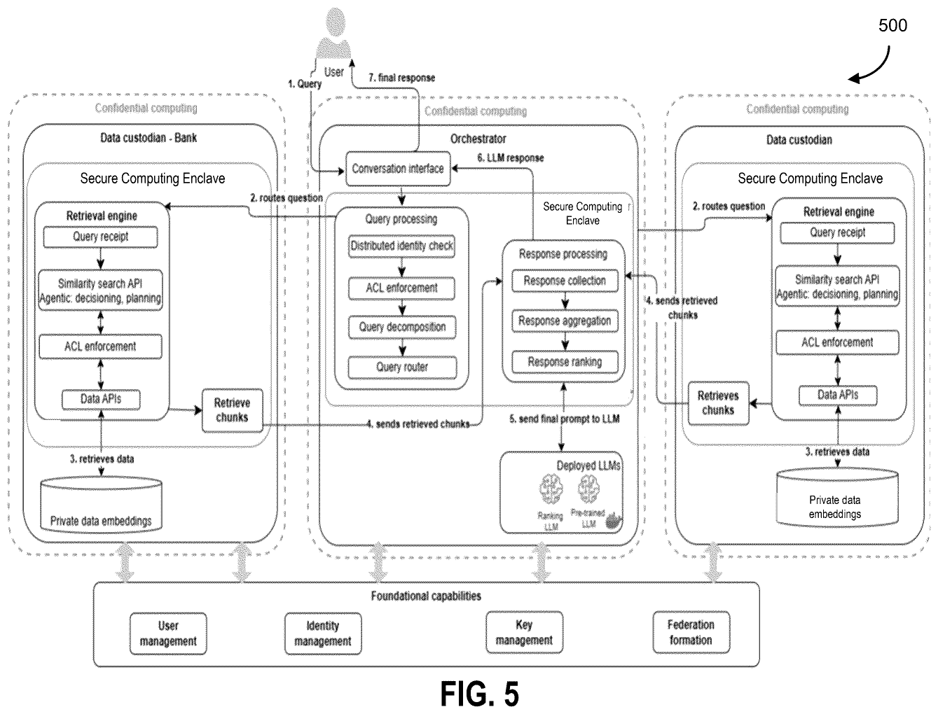

FIG. 5 is a block schematic 500 for a practical implementation variation of the federated confidential machine learning approach used in respect of a large language model recommender engine, according to some embodiments. A combination of local and global orchestration is utilized so that confidential data, in raw form, is not transmitted from any of the local nodes, and rather, only embeddings, such as vector embedding data sets, are transmitted from the local nodes from local classifications generated using a local copy of the model.

As shown in FIG. 5, there are multiple confidential computing stacks, and these are operating on segregated computing devices that are configured only for very limited and controlled interactions. The example shown has two different types of data custodians, in this example, a bank and a merchant, but other variations are possible, including homogenous data custodians, such as multiple merchants working together, or heterogenous data custodians, such as multiple merchants working with multiple banks and multiple insurance companies, for example.

What is important to note is that each of the custodians have local data, which are represented in the form of private data embeddings. The confidential computing can operate on specific computing platforms that are adapted specifically for confidential computing that provide increased hardware, software, or a combination thereof of technical protection measures to further limit access through mechanisms such as encryption at rest and specific key storage/access. This also helps with encryption in transmit as the keys can be used for also transmissions (e.g., sending gradients in the form of update data chunks or embeddings to the orchestrator device).

As shown in FIG. 5, the orchestrator device receives a query at step 1, this query can optionally be pre-processed to append information such as ACL access permissions, originating user identity (e.g., by coupling additional metadata in an overall encapsulated data package) is routed at step 2 to individual data custodian local instances (e.g., through point to point or across a message bus). At step 3, the individual data custodians then are configured to run a local version of retrieval and augmentation against the local private data embeddings. At step 4, the locally calculated/determined data chunks are transmitted back to the orchestrator device, and used as intermediate response inputs for collection, aggregation, ranking, among others. At step 5, a combined set of response inputs are inserted into a prompt data object and provided to a local large language model that is pre-trained for semantic output generation relative to the original query.

ACL permissions can be used for selecting which local nodes are available for usage (e.g., local nodes may have associated access requirements, such as whitelists and blacklists), and similarly, even within local nodes that are available for usage, individual data records, data tables, etc., may have permission parameters that control which can be used for retrieval and augmentation operations for a particular query. These ACL permissions help further enforce privacy both at the machine learning node level and to the individual RAG level during federated RAG. Querying a ACL permission can include using the ACL metadata and receiving a boolean response of TRUE or FALSE as to whether the operation is permissible.

In this example, a confidential federated machine learning architecture is described where the local nodes are local parties formed as a federation that are collaborating to train a model jointly, using a combination of synthetic and public datasets. Each of the local nodes can be run in separate facilities, or in some embodiments in the same facility, but “air gapped” from one another such that they do not have direct interconnections with one another. The local nodes can be coupled to one or more global nodes.

Both the local nodes and the global nodes can be configured to store the models and control access to the models through segregated/limited access secure enclaves or trusted execution environments and corresponding protected processors and memory such that the trained model architectures cannot be accessed directly to obtain the underlying model weights. Rather, in the segregated/limited access secure enclaves or trusted execution environments, the only access is limited to a limited subset of permitted application programming interfaces and their corresponding functionality.

The global model can be jointly trained using a combination of local updates being provided to a global update function, where an aggregator engine receives the local updates for a given query and aggregates the responses to generate global gradients for updates. These global gradients representing a global model to be transmitted to each of the local instances to update the local model instance to match the global model.

With a trained large language model, the large language model can be deployed for inference usage, in this example, responding to a received query string relating to a product recommendation. The query string can represent a type of hybrid search that is required, which is a combination of a syntactic type search (based on the words provided), as well as a semantic type search (where there are meanings and interconnections embedded between the words based on semantic relationships within a particular language. Large language models are well suited for these types of searches.

When a new query string is received, the individual queries can be transmitted to each of the local nodes for a RAG based response generation. Each of the local nodes, in conjunction with local data and the local copy of the model (the model can also be deployed in the central aggregator/orchestrator for inference) generates an output string, and returns the results in the form of a confidential gradient or response string to the central aggregator device. The local node retrieves local data from the locally available data sets, augments the query using local data queries. The locally available data sets differ from node to node.

The central aggregator device receives the local outputs and re-runs the query against a combination of the local node outputs and a copy of the global model to generate a consolidated response string, which is output to the user. By using the global model to generate the consolidated response string, the central aggregator device uses the global model resolve potentially conflicting responses, or to combine two incomplete responses to generate a more coherent or globally representative response. The generation of the consolidated response string can include first using the global model to rank the information from the various local nodes based on an estimated level of accuracy, attach weights to each of the local responses based on their estimated level of accuracy, and then re-running the global model to combine the local responses (the global model will receive the final prompt and will generate a recommendation). The prompt itself can be a data structure having ranked slots, such as an array. Each of the local responses can be assigned a relevancy score, and the rankings can be established in the array. The prompt can be combined with conflict resolution instructions to prefer higher ranked responses over lower ranked responses, for example, ranking or weighting them by their relevancy score, in either absolute or relative terms.

In a further embodiment, the local node outputs are used to re-train and refine the global model, and the model aggregator device is configured to generate updated gradient embeddings for transmission to each of the local nodes to update a local model. In another variant embodiment, instead of updating after every search, local node outputs are batched together for periodic batch training of the global model and periodic model updates that are pushed across all of the local models and the global model.

In another variant embodiment, the local models and the global models are operated with a permitted range of training drift as the models are not necessarily updated in synchronously.

In another variant embodiment, the global model, during updates, is configured to automatically flag responses generated by individual local nodes that are not compatible with one another and cannot be reconciled by the model aggregator device at a high level of confidence.

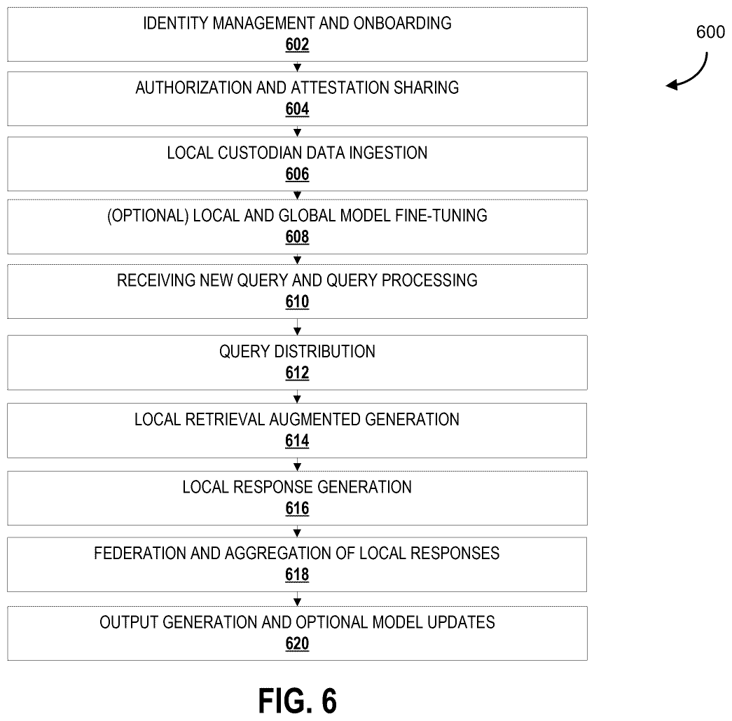

FIG. 6 is an example process diagram showing an example method for federated LLM operating in a federated RAG configuration, according to some embodiments.

At 602, an identity management step is provided where the parties are onboarded and are assigned their own provisioned identities. Each party can operate one or more local nodes, and have an internal key management process.

At 604, each party (data and model custodians) and their corresponding nodes are authenticated in the platform. In some embodiments, this authentication process can include the sharing of current attestations data object based on an agreed upon collaboration schema or federation collaboration data object that represents agreed upon terms, as well as confidential nonces that were provided as part of the onboarding process.

In a variant embodiment, each of the parties is assigned a public private key pair as part of the onboarding process, the public keys are shared as between the parties, and the attestations are further signed or encrypted using the corresponding private key to ensure that only the local node with the corresponding private key was the originator of the attestation. As part of the authorization and attestation, authorization policies for accessing resources (data, models) are thus defined for data, model custodians and users, limiting, for example, in ACL policies, what functionality each type of entity and their associated identifier are allowed to use.

At 606, each data custodian local node can undergo their own process for data preparation, such as preparing their data for ingestion into a vector database. This can include data preparation: cleaning, transforming, and enriching the data, as well as embedding generation for their data using a pre-approved embedding model, specified by the model owner or orchestrator (to ensure consistency across the federation). Embeddings and associated metadata are stored in a local vector database, managed by the data custodian.

At 608, optionally, the individual nodes can interoperate with a global node and generate training sets of embeddings for fine tuning a global large language model for domain specificity using the data sets uploaded into each data custodian local node. This can be conducted to improve domain specificity of the global model. In alternate embodiments, however, a large language model can be used without specific re-training using the uploaded data sets from each custodian.

Each node is provided with a local model. In some embodiments, each local model is the same, while in other embodiments, the local models may vary from one another through local training or local model selection.

At 610, the federated LLM/RAG approach is operated in inference for query processing. The central orchestrator node receives across a message bus a query from a tenant or user, and generates an embedding representative of the user query. When receiving the query, which can be a query string or a query data object having multimodal inputs, for example, the central orchestrator node is configured to conduct a federated identity check by verifying the user's identity and group memberships against a federated identity management system, and may also enforce an access policy based on the user's identity and the data access policies defined by the data owners to determine which data sources the user is authorized to query.

The queries can include profile selections (student, traveller, worker), as well as different input options. Example queries include “I am going for a week on a mountain trek, which items do I need?”, “I have a formal winter wedding to attend next month. What should I wear?”, “I'm starting a new job at a tech startup with a casual dress code. What items should I add to my cart” ?. Additional query portions can be requested in an interface, such as a goal selection (“Choose your goal or enter a custom one”). These inputs can then be used to generate a query, in this example, a fashion recommendation.

The query can be expanded with ACL information for example, in the form of metadata.

At 612, the central orchestrator node distributes the query to the authorized data owners. As the query may be sensitive, in some embodiments, the query is encrypted prior to transmission. The distribution of the query can be across a message bus, it can be broadcasted, or it can be placed on a buffer, according to different embodiments. The query distribution can also be using point-to-point communications.

At 614, each of the local nodes corresponding to the data custodians receive the query and conduct retrieval augmentation of the query, for the purposes of generating a local response. Upon receiving a query, the data owner's vector database performs a similarity search (syntactic and semantic) to first identify relevant data. In some embodiments, an ACL check is conducted at this stage to verify at a local level that the query requesting party is able to access this data as part of the query being executed locally.

At 616, the local node (data owner) generates a preliminary response based on the retrieved local data. This response may include text snippets, data points, or other relevant information. The data owner encrypts the response using the tenant's public key or a shared secret key established during onboarding. This ensures data confidentiality during transit.

At 618, the responses are received, aggregated and refined by the central orchestrator device (acting as the global node). The central orchestrator collects the encrypted responses from the data owners, decrypts the responses using the appropriate key (e.g., the stored public keys). Each of the responses is effectively a retrieved chunk of information that may partially or fully respond to the query.

The retrieved chunks of information are then processed using an aggregation approach by the orchestrator to combine the responses from different data owners into a single, coherent response. In a variant embodiment, the global node is further configured to include a prompt builder module that is configured to apply a specific prompt template on retrieved chunks from data custodians to augment the retrieved chunks, and a final prompt data object including all of the retrieved chunks in the format of the prompt template can then be provided to the global model (e.g., global LLM) to generate the response. In some embodiments, the prompt template includes instruction sets on conflict resolution where conflicting retrieved chunks have been obtained.

In a variant embodiment, in some embodiments, the global response generation may include additional steps of first ranking the results by operating the global model to generate confidence scores, removing duplicates, or adding additional context such as the original query again as an input. By adding the original query again as an information signal, it helps prevent potential issues with catastrophic forgetting and helps prime the response generation for increased adherence to responding to the original query. From a practical implementation perspective, the additional steps can be implemented through the prompt data object having specific pre-built wording and resolution commands, and these resolutions can include incorporating a voting mechanism or a confidence-based weighting approach, among others. In another variant, the approach includes also generating a summarized version of the recommendation, using the global model for identifying specific output portions or tokens with additional graphical rendering characteristics (e.g., bold, highlighting) to emphasize key features.

At 620, the final response can be delivered back to a particular tenant or user through their local node, for example. In a variant embodiment, as described herein, the global and local models can be periodically updated based on the federated RAG results being used as a learning dataset, updating weights based on received user feedback, or a lack thereof of user feedback (thus indicating that the response was potentially acceptable). In this variant embodiment, the periodic update can include operating the global model in a retraining mode based on the retrieved chunks to output gradients, and then re-circulating these gradients back to the local nodes to update their local models.

From a use case perspective, there can be different practical integration of the federated learning approaches described herein, especially the use of federated RAG in combination with federated LLM.

A number of different proposed architectures are provided that can be used for federated training and federated inference. The federated training approaches described herein can be utilized in optional embodiments, and are not necessarily present in all embodiments. However, the federated operation for inference is the core feature for federated RAG, where during inference operation, the federation includes transmitting confidential queries for federated retrieval augmentation of the query at the local node level, and then federating the responses for central processing by one or more central orchestrator nodes. In some embodiments, there can be multiple tiers of orchestration/local nodes (e.g., two layers of global orchestrator nodes). In federated inference, a federated improvement to RAG is proposed that incorporates additional local information from the local nodes during the generation process to augment the local model's existing representation, retrieving relevant information from the local knowledge base for improving the quality of the response. The local search can include a retrieval process by querying the local databases to identify relevant information to augment to the processing of the query against the trained model. At the local level, a combined input is thus provided—the LLM's semantic knowledge and the retrieved local information are used together to generate the local response, allowing the approach to access and incorporate new or domain-specific knowledge that may only be privately available and not widely available, while utilizing the predictive capability of the local model.

As described herein, in an optional variation, federated inference is combined with federated training such that after federated inference, the intermediate results are added to a training dataset for first updating the global model, and then those updates can be pushed to local models for updating the local models as well, such that the results from the local response generation are used both for federated training and federated inference.

An example can include automotive parts sourcing, where a number of different vendors are possible sellers of a particular part. Each of the local nodes are custodians of their local inventory information, which can include part descriptions, inventory levels, quality levels, pricing levels, and the qualifying parts can be identified, for example, by SKU numbers.

Another set of local nodes can include dealerships, or other data custodians with varying levels of information about the particular customer or a particular make or model of vehicle.

A query can be provided to the global model requesting assistance with a particular situation, and the query can include multiple elements of information, such as “John Smith is looking for a compatible oil filter for his 1996 Ford F-350 pickup truck having the LX trim, John Smith lives in Alexandria and is a student with a limited budget. What do you recommend?”. When the query is sent to each of the local nodes, they are able to conduct an improved retrieval augmentation at a local level using the different elements of information.

For example, some local nodes will simply return “Not sure what kind of filter is needed”, or “There are no compatible filters in stock”. However, some local nodes are also able to use their local competition sensitive information, such as “While that type of filter has been out of stock, the system has tracked successful installations of another type of filter and that type of filter could potentially be compatible”, or specific information such as available price incentives and discounts, as well as the location and availability of the suggested filter, or specific information about John Smith or his specific truck (e.g., the dealership that had previously serviced his vehicle).

Another type of local node can include John Smith's bank, which can return other useful information (despite not being able to answer the query), such as “John Smith can responsibly only budget $50 for this purchase”.

Accordingly, a number of local nodes may return useful results to the global node, such as “The OEM filter for this vehicle is SKU #XX. Within an acceptable distance from Alexandria, there is a promotion at franchise #XX. The price is $150 because it is discontinued and there is low stock despite the promotion”. Another useful result might be “The OEM filters for his vehicle are discontinued and we do not have any stock, but our system indicates that another type of filter is compatible is aftermarket filter XX, which is in stock and at $30”. However, each of the responses individually may be confidential as the companies wish to keep their pricing and availability their competitive trade secret. These useful results were conducted through an improved retrieval of data local to the data custodian to augment the query with additional data elements before local generation of the local response results.

The global node receives each of the local responses as retrieved chunks, and these responses may occasionally conflict with one another factually, or represent partial solutions. In this auto part finder example, the specific oil filter being sought after is discontinued and stock is low or non-existent, and the irrelevant or non-useful results can be discarded. The remaining results can be ranked and weighted by processing the intermediate results and the query again against the global model to obtain a weighting/relevance/confidence score, and the results can be combined together and aggregated to generate the final output, in accordance with an output formatting prompt. The final output response in this example can be “While there is an OEM filter available for your vehicle, unfortunately it is discontinued and only available at an unacceptable price due to limited availability. However, there appears to be a compatible filter with a strong track record of performance for your exact vehicle, aftermarket filter XX and there is availability at parts store XX. The estimated price is $30, and there is a promotion.”

Another practical variation includes the usage of the system for federated inference across a number of financial institutions that are configured to operate together to prepare a response for a particular query, but cannot share information directly with one another. For example, a query about a particular company's financial position from the company's chief financial officer can be submitted confidentially to the orchestrator device, which can be a trusted third party machine learning orchestrator node that is coupled through application programming interfaces to local nodes at each data custodian, which in this example could be a number of different financial institutions. The query can include information about the particular company, such as the address, the name of the company, and the information being sought.

Each of the financial institutions locally queries local data storage, which can include sensitive information such as the bank account numbers, the amount of funds stored therein, recent transactions, etc. Each financial institution processes the query as a local node, and in this processing, the retrieval and augmentation approach includes first identifying among the local node's available databases, the corresponding databases to be queried, and using this information to augment the query, generating a local response. The local response is converted into a data chunk, which can include a one way transformation into an embedding data object that is representative of the response but is difficult or impractical to decompile or otherwise reverse engineer into the original response. These are collated by the orchestrator device in this example and inserted into a prompt for re-running at a global level LLM, which then generates an output indicative of all of the examples combined together. An example output can be that the company's aggregate accounts have XX, across banks X, Y, and Z.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended embodiments are intended to include within their scope such processes, machines, manufacture, compositions of matter, means, methods, or steps.

As can be understood, the examples described above and illustrated are intended to be exemplary only.

What is claimed is:

1. A computer implemented system for a federated machine learning orchestration environment maintaining an always protected processing subsystem, the system comprising:
a computer readable memory having a protected memory region that is encrypted such that it is inaccessible to both an operating system and kernel system, the protected memory region including at least a data storage region and a data processing subsystem storage region maintaining the always protected data processing subsystem;
a computer readable cache memory; and
a secure enclave data processor configured to:
receive a new query data object;
transmit the new query data object to a plurality of target secure enclave data processors, each corresponding to a local machine learning orchestration environment, each of the target secure enclave data processors operating a local machine learning model in an inference mode to first retrieve from a local data storage relevant local data records, and then operating the local machine learning model to generate an intermediate response to the new query data object using the new query data object augmented with one or more private embeddings corresponding to the retrieved relevant local data records;
receive a plurality of intermediate responses from each of the target secure enclave data processors;
insert the plurality of intermediate responses into a consolidated data structure;
process the consolidated data structure by operating a global machine learning model in an inference mode against the consolidated data structure and the new query data object to generate an output data object representing a predictive response to the new query data object; and
transmit the output data object representing the predictive response to a user interface computing system configured for dynamically rendering one or more visualization outputs based on the output data object and the predictive response.

2. The system of claim 1, wherein the local machine learning model and the global machine learning model are both a same version of a trained large language model.

3. The system of claim 2, wherein after generating the output data object, the global machine learning model is retrained using the plurality of intermediate responses.

4. The system of claim 3, wherein the retraining of the global machine learning model is conducted on a periodic basis on periodic batches of intermediate responses.

5. The system of claim 3, wherein after retraining of the global machine learning model, model update gradients are generated, and the model update gradients are transmitted to each of the plurality of target secure enclave data processors, each of the plurality of target secure enclave data processors configured to update the corresponding local machine learning model using the model update gradients.

6. The system of claim 2, wherein the consolidated data structure is structured as a prompt having a plurality of ranked slots, and the secure enclave data processor is configured to operate the global machine learning model in the inference mode upon receiving the plurality of intermediate responses to rank each of the plurality of intermediate responses based on relevance to the new query data object, and to insert the plurality of intermediate responses into the ranked slots of the prompt.

7. The system of claim 6, wherein the prompt includes a conflict resolution instruction to bias the generation of the output data object to weight higher ranked intermediate responses over lower ranked intermediate responses of the plurality of ranked slots.

8. The system of claim 1, wherein the new query data object includes access credential metadata, and the access credential metadata is utilized by each of the local machine learning model to control which of the relevant local data records of the local data storage are made available for generation of the intermediate response.

9. The system of claim 1, wherein the new query data object includes access credential metadata, and the access credential metadata is utilized by the secure enclave data processor to identify the plurality of target secure enclave data processors.

10. The system of claim 1, wherein the computer implemented system for the federated machine learning orchestration environment resides in a data center and is coupled to a message bus to receive the new query data object from a user interface coupled to a terminal device associated with a user and to transmit the new query data object to the plurality of target secure enclave data processors.

11. A computer implemented method for a federated machine learning orchestration environment operating on an always protected processing subsystem, the method comprising:
receiving a new query data object;
transmitting the new query data object to a plurality of target secure enclave data processors, each corresponding to a local machine learning orchestration environment, each of the target secure enclave data processors operating a local machine learning model in an inference mode to first retrieve from a local data storage relevant local data records, and then operating the local machine learning model to generate an intermediate response to the new query data object using the new query data object augmented with one or more private embeddings corresponding to the retrieved relevant local data records;
receiving a plurality of intermediate responses from each of the target secure enclave data processors;
inserting the plurality of intermediate responses into a consolidated data structure;
processing the consolidated data structure by operating a global machine learning model in an inference mode against the consolidated data structure and the new query data object to generate an output data object representing a predictive response to the new query data object; and
transmitting the output data object representing the predictive response to a user interface computing system configured for dynamically rendering one or more visualization outputs based on the output data object and the predictive response.

12. The method of claim 11, wherein the local machine learning model and the global machine learning model are both a same version of a trained large language model.

13. The method of claim 12, wherein after generating the output data object, the global machine learning model is retrained using the plurality of intermediate responses.

14. The method of claim 13, wherein the retraining of the global machine learning model is conducted on a periodic basis on periodic batches of intermediate responses.

15. The method of claim 13, wherein after retraining of the global machine learning model, model update gradients are generated, and the model update gradients are transmitted to each of the plurality of target secure enclave data processors, each of the plurality of target secure enclave data processors configured to update the corresponding local machine learning model using the model update gradients.

16. The method of claim 12, wherein the consolidated data structure is structured as a prompt having a plurality of ranked slots, and the method comprises operating the global machine learning model in the inference mode upon receiving the plurality of intermediate responses to rank each of the plurality of intermediate responses based on relevance to the new query data object, and to insert the plurality of intermediate responses into the ranked slots of the prompt.

17. The method of claim 16, wherein the prompt includes a conflict resolution instruction to bias the generation of the output data object to weight higher ranked intermediate responses over lower ranked intermediate responses of the plurality of ranked slots.

18. The method of claim 11, wherein the new query data object includes access credential metadata, and the access credential metadata is utilized by each of the local machine learning model to control which of the relevant local data records of the local data storage are made available for generation of the intermediate response.

19. The method of claim 11, wherein the new query data object includes access credential metadata, and the access credential metadata is utilized to identify the plurality of target secure enclave data processors.

20. A non-transitory computer readable medium storing machine interpretable instructions, which when executed by a processor, cause the processor to perform steps of a computer implemented method for a federated machine learning orchestration environment operating on an always protected processing subsystem, the method comprising:
receiving a new query data object;
transmitting the new query data object to a plurality of target secure enclave data processors, each corresponding to a local machine learning orchestration environment, each of the target secure enclave data processors operating a local machine learning model in an inference mode to first retrieve from a local data storage relevant local data records, and then operating the local machine learning model to generate an intermediate response to the new query data object using the new query data object augmented with one or more private embeddings corresponding to the retrieved relevant local data records;
receiving a plurality of intermediate responses from each of the target secure enclave data processors;
inserting the plurality of intermediate responses into a consolidated data structure;
processing the consolidated data structure by operating a global machine learning model in an inference mode against the consolidated data structure and the new query data object to generate an output data object representing a predictive response to the new query data object; and
transmitting the output data object representing the predictive response to a user interface computing system configured for dynamically rendering one or more visualization outputs based on the output data object and the predictive response.
